(19) United States
(12) Patent Application Publication
(10) Pub. No.: US 2022/0058223 A1
(43) Pub. Date: Feb. 24, 2022

(54) INFORMATION SEARCH APPARATUS AND NON-TRANSITORY COMPUTER READABLE MEDIUM

(71) Applicant: FUJIFILM BUSINESS INNOVATION CORP., Tokyo (JP)

(72) Inventor: Hayahide YAMAGISHI, Kanagawa (JP)

(73) Assignee: FUJIFILM BUSINESS INNOVATION CORP., Tokyo (JP)

(21) Appl. No.: 17/163,632

(22) Filed: Feb. 1, 2021

(30) Foreign Application Priority Data
Aug. 18, 2020 (JP) 2020-137876

(51) Int. Cl. G06F 16/9035; G06F 16/9032; G06F 16/9038

(52) U.S. Cl. CPC G06F 16/9035; G06F 16/9038; G06F 16/90324

(57) ABSTRACT

An information search apparatus includes: a receiver configured to receive an input of a user; and a processor configured to execute a program to execute a first search based on a query input to the receiver to generate first search results, generate a related query from the query, execute a second search based on the related query to generate second search results, integrate the first search results and the second search results into a set of search results, and output the set of search results as search results for the query.

### CROSS-REFERENCE TO RELATED APPLICATIONS

This application is based on and claims priority under 35 USC 119 from Japanese Patent Application No. 2020-137876 filed Aug. 18, 2020.

### BACKGROUND

### (i) Technical Field

The present disclosure relates to an information search apparatus and a non-transitory computer readable medium.

### (ii) Related Art

In the related art, there has been proposed a technique of receiving a query from a user, searching a database registered in advance for similar data to the query, and returning a search result.

Japanese Patent No. 4912384 describes a document search device that uses a search log of a search engine when searching for an electronic document including a query with which a search is instructed from a user terminal. The document search device includes: a query information storage unit that generates an extension word from a title and a summary sentence of a search result corresponding to a query included in the search log and stores the extension word as extension information of the query; a search result information storage unit that determines a query with which a search of a search result that is clicked from the search log is made, obtains the extension word related to the query from the query information storage unit, and stores an extension word group of a query input when the search result is clicked as extension information of the search result; a collation processing unit that, for the query with which a search is instructed from the user terminal, acquires the extension word of the query from the query information storage unit and sends the extension word to the user terminal; and a search result processing unit that extends a search result by adding the extension word group stored in the search result information storage unit to a search result obtained by searching with an extension query obtained by extending the query with which a search is instructed, sorts the extended search result according to a similarity to the extension query, and sends a final search result in which the sorted result is listed to the user terminal.

Japanese Patent No. 6299596 describes a query similarity evaluation system that determines whether search intentions of plural input queries are similar. The system includes: a search result ranking unit that determines a first importance of each of plural documents based on evaluation results of the plural documents that are searched with a first query, and determines a second importance of each of the plural documents based on evaluation results of the plural documents that are searched with a second query; and a query similarity calculation unit that calculates a similarity among the plural queries based on the first and second importance of each document in a document cluster. The search result ranking unit specifies a characteristic word of a document having a high evaluation and a document having a low evaluation, and calculates an importance of a document having a high appearance frequency of the characteristic word of the document having a high evaluation to be high and an importance of a document having a high appearance frequency of the characteristic word of the document having a low evaluation to be low.

### SUMMARY

By extending a query received from a user, a search system can search a range wider than a search result that is obtained by searching only with the received query. However, in a configuration in which the search result for the received query is returned to a user and the query is extended based on a click log of the user, a large amount of click logs are required as a premise for extending the query.

Aspects of non-limiting embodiments of the present disclosure relate to providing a technique capable of extending a received query and searching with the extended query even when there is no click log of a user for a search results.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information search apparatus including: a receiver configured to receive an input of a user; and a processor configured to execute a program to execute a first search based on a query input to the receiver to generate first search results, generate a related query from the query, execute a second search based on the related query to generate second search results, integrate the first search results and the second search results into a set of search results, and output the set of search results as search results for the query.

### BRIEF DESCRIPTION OF THE DRAWINGS

Exemplary embodiment(s) of the present disclosure will be described in detail based on the following figures, wherein:

FIG. 1 is a diagram showing a configuration of a system according to an exemplary embodiment;

FIG. 2 is a schematic explanatory diagram showing search results according to the exemplary embodiment;

FIG. 3 is an explanatory diagram showing search results for “telework” according to the exemplary embodiment;

FIG. 4 is an explanatory diagram showing search results for “remote work” according to the exemplary embodiment;

FIG. 5 is an explanatory diagram showing integrated search results according to the exemplary embodiment;

FIG. 6 is an explanatory diagram showing a process according to the exemplary embodiment;

FIG. 7 is an explanatory diagram showing another process according to the exemplary embodiment;

FIG. 8 is an explanatory diagram showing further another process according to the exemplary embodiment;

FIG. 9 is an explanatory diagram showing still another process according to the exemplary embodiment; and

FIG. 10 is an explanatory diagram showing still further another process according to the exemplary embodiment.

### DETAILED DESCRIPTION

Hereinafter, an exemplary embodiment of the present disclosure will be described with reference to the drawings.

First, a basic principle of the present exemplary embodiment will be described.

In a search system that receives a query from a user, in response, searches a database registered in advance for similar data, and returns the similar data to the user, search accuracy can be improved by learning using registered data and other data. Here, the term “query” refers to an inquiry or a processing request to a database management system or the like, and generally represents a processing request such as data extraction or data update in a character string. In the search system, a set including (i) a query, (ii) search results obtained for the query, and (iii) a browsing behavior (for example, a click behavior) performed by a user for the search results can be accumulated as a log (click log).

On the other hand, in the search system, it is not uncommon to obtain completely different search results due to (i) spelling inconsistencies and (ii) terms with similar meanings, but different written forms. An example of the spelling inconsistencies is a term “center” and a term “centre”, which lead to different search results. Terms with similar meanings, but different written forms may also be referred to as synonyms or paraphrased terms. For example, “telework” and “remote work”, which have similar meanings, but written in different forms, lead to different search results. The difference in the search results due to such spelling inconsistencies and terms with similar meanings, but different written forms may or may not be beneficial to the user.

In order to obtain results of a search with a term related to a user input query as well as results of a search with the user input query, one skilled in the art may prepare a related word data set. However, it is costly and time-consuming to manually prepare the related word data set. This is because it is difficult to determine a scale for similarities between related words.

Thus, in the present exemplary embodiment, an information search apparatus automatically generates a related query for a query received from a user, searching with the original query received from the user and searching with the related query generated automatically are performed simultaneously, and these search results are integrated into a single set of search results, and the single set of search results is presented to the user. The related query may be generated directly or indirectly from the original query. Examples of a method for generating the related query directly from the original query include (i) generating a part of the original query as the related query, and to (ii) generating the related query from user information of the user who has input the original query. A method for generating the related query indirectly from the original query generates the related query using the search results for the original query.

The user checks the single set of integrated search results and performs a browsing behavior such as clicking on a search result desired by the user. The information search apparatus can evaluate a similarity between the original query and the related query using the browsing behavior of the user, and accumulate a result of the similarity evaluation to construct a related word data set for a certain word.

Since the present exemplary embodiment automatically generates the related query from the query received from the user, it is not necessary to provide the related word data set in advance. In other words, a click log of the user for constructing the related word data set is not required in advance.

Next, a specific configuration and process according to the present exemplary embodiment will be described.

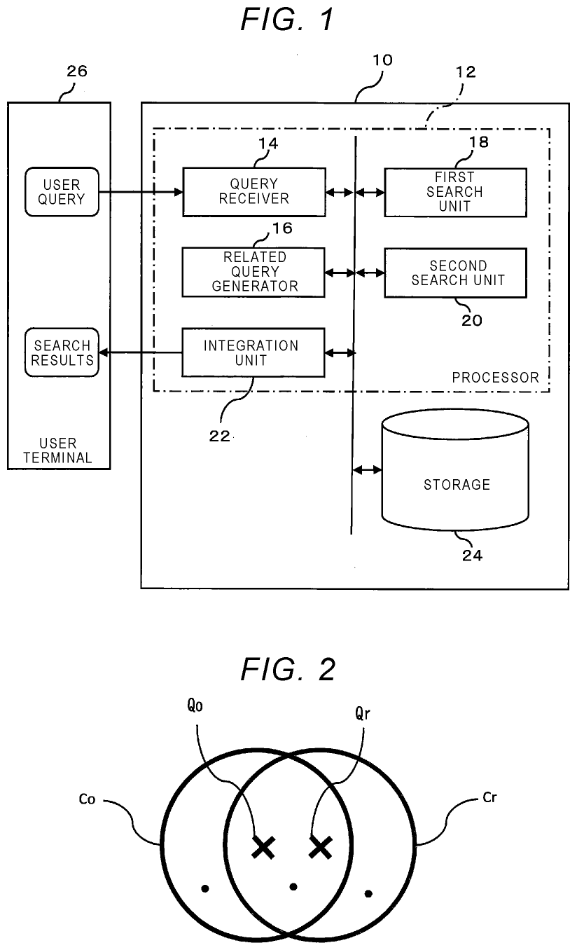

FIG. 1 is a block diagram showing a configuration of a system according to the present exemplary embodiment. The system includes an information search apparatus 10 and a user terminal 26. The information search apparatus 10 and the user terminal 26 are connected to each other via a communication line to transmit and receive data. The communication line may be a public line or a dedicated line and may be wired or wireless communication line. An example of the communication line is the Internet. However, the communication line is not limited to this example.

Specifically, the information search apparatus 10 is implemented by a computer. The computer includes a processor 12 and a storage 24.

The processor 12 includes, as functional blocks, a query receiver 14, a related query generator 16, a first search unit 18, a second search unit 20, and an integration unit 22.

The query receiver 14 receives a query (user query) from the user terminal 26. The whole system according to the present exemplary embodiment is configured as a search system that receives a query from a user terminal, in response, searches a database for data corresponding to the query, and returns the data to the user terminal.

The related query generator 16 automatically generates a related query from the user query received by the query receiver 14. Specifically, the related query generator 16 generates the related query using the search results obtained by searching with the user query received by the query receiver 14.

The first search unit 18 searches the database stored in the storage 24 based on the query received by the query receiver 14, and outputs the search results for the query.

The second search unit 20 searches the database stored in the storage 24 based on the related query generated by the related query generator 16, and outputs the search results for the related query.

The integration unit 22 integrates the search results obtained by the first search unit 18 and the search results obtained by the second search unit 20, and returns the integrated search results to the user terminal 26 as search results for the user query received by the query receiver 14. Accordingly, the user will receive the single set of integrated search results as the search results for the user query.

The storage 24 includes an HDD, an SSD, or the like and stores the database. The storage 24 is provided in the same computer as the first search unit 18 and the second search unit 20 in FIG. 1. Alternatively, the storage 24 may also be provided independently of the information search apparatus 10 and connected to the information search apparatus 10 via the communication line.

The processor 12 implements the query receiver 14, the related query generator 16, the first search unit 18, the second search unit 20, and the integration unit 22 by executing a program. The processor 12 refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device). The processor 12 is broad enough to encompass one processor or plural processors in collaboration which are located physically apart from each other but may work cooperatively.

FIG. 2 schematically shows the user query, the related query, the search results for the user query, and the search results for the related query according to the present exemplary embodiment. Qo indicates the user query, and Qr indicates the related query. The search results for the user query Qo is indicated by a set Co, and the search results for the related query Qr is indicated by a set Cr.

It is assumed that Cr includes a user-intended search result. In this case, it can be said that a similarity between the user query Qo and the related query Qr is high. On the other hand, search results only belonging to Co may be noise for the user.

It is assumed that Co includes a more user-intended search result than those in Cr. In this case, a similarity between the user query Qo and the related query Qr is low, and the user may strictly use both of Qo and Qr. When none of Co and Cr includes a user-intended search result, both Co and Cr are noise and a similarity between the user query Qo and the related query Qr is low.

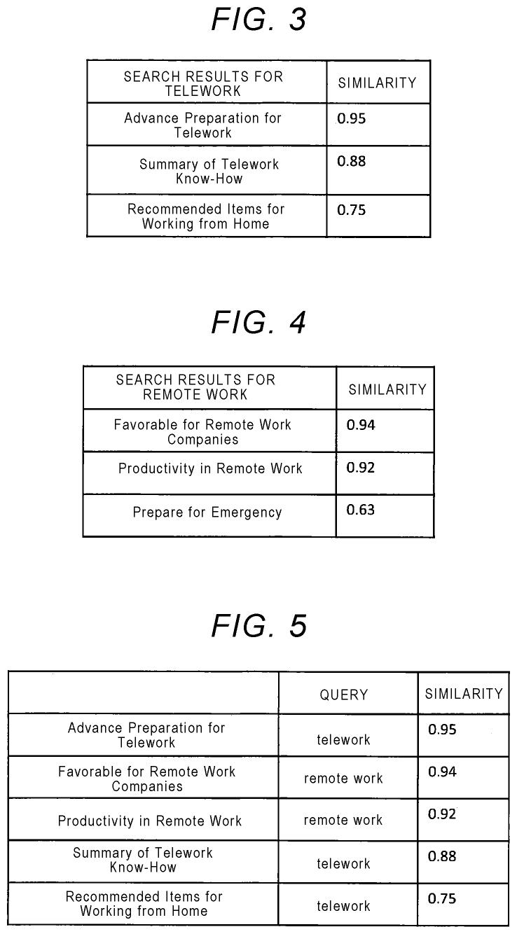

FIG. 3 shows an example of the search results when “telework” is received as the user query Qo. When “telework” is input as the user query Qo, the first search unit 18 searches the database, and obtains the following search results:
“Advance Preparation for Telework”,
“Summary of Telework Know-How”,
“Recommended Items for Working from Home”,
   The similarity between each search result and the user query Qo is shown. A search result having a higher similarity to the user query is displayed at a higher rank. The similarity can be calculated by a known calculation method. For example, a cosine similarity of a word vector of a document may be used. The cosine similarity sim between two word vectors x and y is calculated by

sim=x·y/(|x|×|y|)

where x·y=the inner product of vectors x and y. The closer the cosine similarity is to 1, the more similar the vectors x and y are. The closer the cosine similarity is to 0, the less similar the vectors x and y are. In place of the cosine similarity, another index such as Pearson's correlation coefficient or deviation pattern similarity may be used.

FIG. 4 shows an example of the search results when “remote work” is received as the related query Qr. When “remote work” is input as the related query Qr, the second search unit 20 searches the database, and obtains the following search results:
“Favorable for Remote Work Companies”,
“Productivity in Remote Work”,
“Prepare for Emergency”,
   A search result having a higher similarity to the user query is displayed at a higher rank.

The integration unit 22 integrates these search results into a single set of search results and presents the single sets of search results to the user.

FIG. 5 shows a result of integrating the search results in FIG. 3 and the search results in FIG. 4. A search result having a higher similarity to a corresponding one of the user query Qo and the related query Qr is displayed at a higher rank. It is assumed that the user clicks “Favorable for Remote Work Companies” of the search results. In this case, the processor 12 evaluates that a similarity between the user query Qo “telework” and the related query Qr “remote work” is high, and registers the user query Qo “telework” and the related query Qr “remote work” in the storage 24 as a related word data set.

Meanwhile, when the user clicks “Advance Preparation for Telework” of the search results, the processor 12 evaluates that a similarity between the user query Qo “telework” and the related query Qr “remote work” is relatively low, and registers the user query Qo “telework” and the related query Qr “remote work” in the storage 24 as an unrelated word data set. That is, the processor 12 stores the user query Qo and the related query Qr in the storage 24 not only when the similarity is high but also when the similarity is low. In the latter case, the processor 12 stores the user query Qo and the related query Qr in the storage 24 as unrelated words.

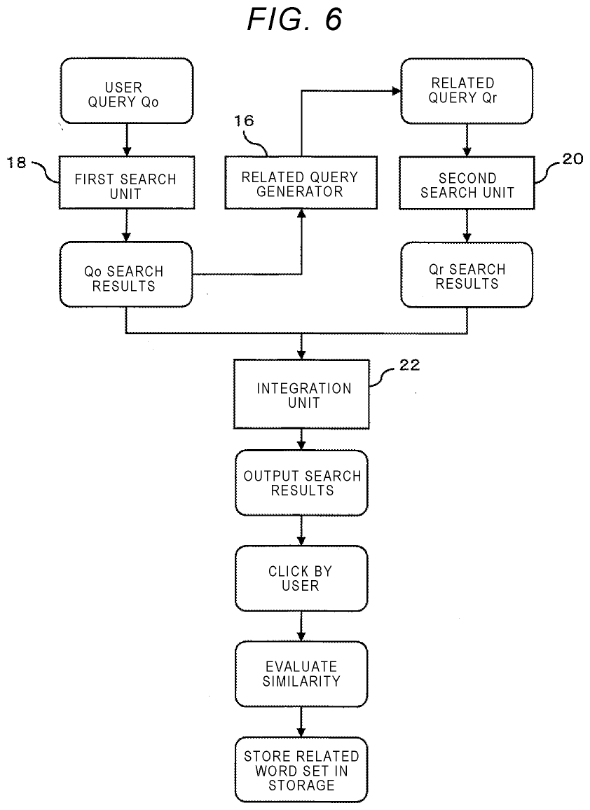

FIG. 6 schematically shows a flow of a process according to the present exemplary embodiment.

When a user query Qo is received by the query receiver 14, the user query Qo is output to the first search unit 18. The first search unit 18 accesses the database, executes a search with the user query Qo, outputs search results (which may be referred to as “Qo search results”) to the integration unit 22 and the related query generator 16.

The related query generator 16 generates a related query Qr to the user query Qo based on the Qo search results. Specifically, the related query generator 16 extracts a part of the Qo search results and uses the part of the Qo search results as the related query Qr. It is assumed that a system receives a title of a paper and searches for a related paper. In this case, the user inputs, for example, “Graph Attention Networks” as the user query Qo. The first search unit 18 accesses the database for the user query Qo, and outputs the followings in descending order of the similarity, as the Qo search results:
“Graph Neural Networks”,
“Graph Attention for Finance”,
“Hierarchical Graph Attention”,

The related query generator 16 extracts a part of the Qo search results, for example, “Graph Neural Networks” listed at the top, employs the part of the Qo search results as the related query Qr, and outputs the related query Qr to the second search unit 20. The second search unit 20 accesses the database to execute a search with the related query Qr, and outputs search results (which may be referred to as “Qr search results”) to the integration unit 22. It is assumed that the Qr search results are as follows in descending order of the similarity:
“Graph Markov Neural Networks”,
“A Survey of Graph Neural Networks”,
“Graph Convolutional Networks”,

The integration unit 22 integrates the Qo search results and the Qr search results to generate the followings in descending order of the similarity:
“Graph Neural Networks”,
“Graph Markov Neural Networks”,
“A Survey of Graph Neural Networks”,
“Graph Convolutional Networks”,
“Graph Attention for Finance”,
   and outputs the integrated search results to the user terminal 26 as the search results for the user query Qo. Since the search results are sorted in descending order of the similarity from the top, that is, a search result having a higher similarity is displayed at a higher rank, the Qo search results and the Qr search results may be mixed.

The user checks the search results displayed on the user terminal 26, and clicks any desired search result to make a request. The processor 12 receives the user's click and evaluates the similarity of the related query Qr to the user query Qo. It is assumed that the user clicks “Graph Convolutional Networks”. In this case, the processor 12 evaluates that a similarity between the user query Qo “Graph Attention Networks” and the related query Qr “Graph Neural Networks” is high, and stores “Graph Attention Networks” and “Graph Neural Networks” in the storage 24 as a related word set.

In view of the user clicking “Graph Convolutional Networks” included in the search results for the related query Qr, the processor 12 stores “Graph Neural Networks” and “Graph Convolutional Networks” in the storage 24 as a related word set.

Further, the processor 12 evaluates, through the related query Qr “Graph Neural Networks”, that the similarity between the user query Qo “Graph Attention Networks” and “Graph Convolutional Networks” is high, and stores “Graph Attention Networks” and “Graph Convolutional Networks” in the storage 24 as the related word set.

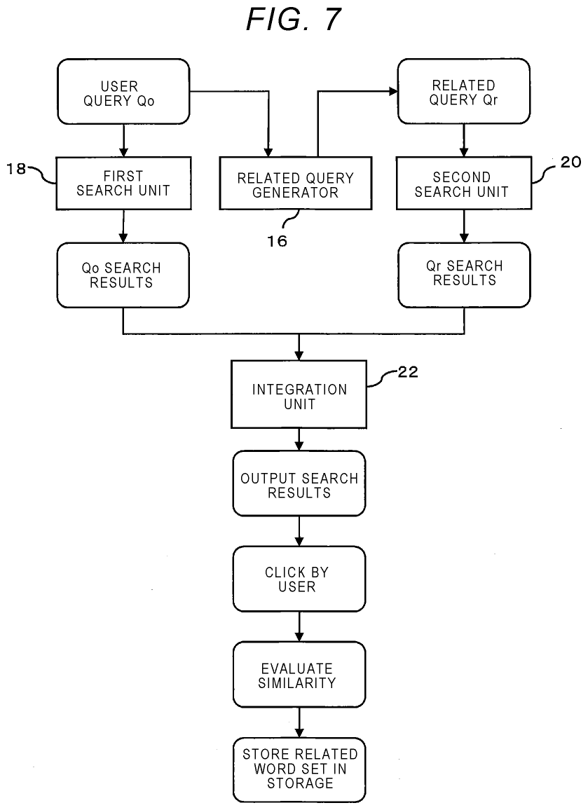

FIG. 7 schematically shows a flow of another process according to the present exemplary embodiment. FIG. 7 shows a search system that presents a paper that may be of interest to a person.

When the user query Qo is received from a certain user Alice by the query receiver 14, a user query Qo is output to the first search unit 18. The first search unit 18 accesses the database to execute a search for the user query Qo, and outputs search results (that is, Qo search results) to the integration unit 22. The search results in this case are papers that may be of interest to Alice. It is assumed that the Qo search results are as follows in descending order of the similarity:
“Graph Neural Networks”,
“Graph Attention for Finance”,
“Hierarchical Graph Attention”,

Meanwhile, it is assumed that the related query generator 16 accesses and searches a database for a person whose interest is close to that of Alice based on the user Alice who has input the user query Qo, and obtains Bob. The related query generator 16 generates Bob as a related query to Alice and outputs Bob to the second search unit 20. The second search unit 20 accesses the database to execute a search with the related query Qr, and outputs search results (that is, Qr search results) to the integration unit 22. It is assumed that the Qr search results are as follows in descending order of the similarity:
“Graph Markov Neural Networks”,
“A Survey of Graph Neural Networks”,
“Graph Convolutional Networks”,

The integration unit 22 integrates the Qo search results and the Qr search results to generate the following set in order of the similarity:
“Graph Neural Networks”,
“Graph Markov Neural Networks”,
“A Survey of Graph Neural Networks”,
“Graph Convolutional Networks”,
“Graph Attention for Finance”,
   and outputs the above set to the user terminal 26 as search results for the user query Qo.

The user checks the search results displayed on the user terminal 26, and clicks any desired search result to make a request. The processor 12 receives the user's click and evaluates the similarity of the related query Qr to the user query Qo. It is assumed that the user clicks “Graph Convolutional Networks”. In this case, the processor 12 evaluates that a similarity between the user Alice of the user query Qo and the user Bob of the related query Qr is high, and store “Alice” and “Bob” in the storage 24 as a related word set.

In view of the user clicking “Graph Convolutional Networks” included in the search results for the related query Qr, the processor 12 stores “Bob” and “Graph Convolutional Networks” in the storage 24 as a related word set.

Further, the processor evaluates, through the related query Qr, that the similarity between the user Alice of the user query Qo and “Graph Convolutional Networks” is high, and stores “Alice” and “Graph Convolutional Networks” in the storage 24 as the related word set.

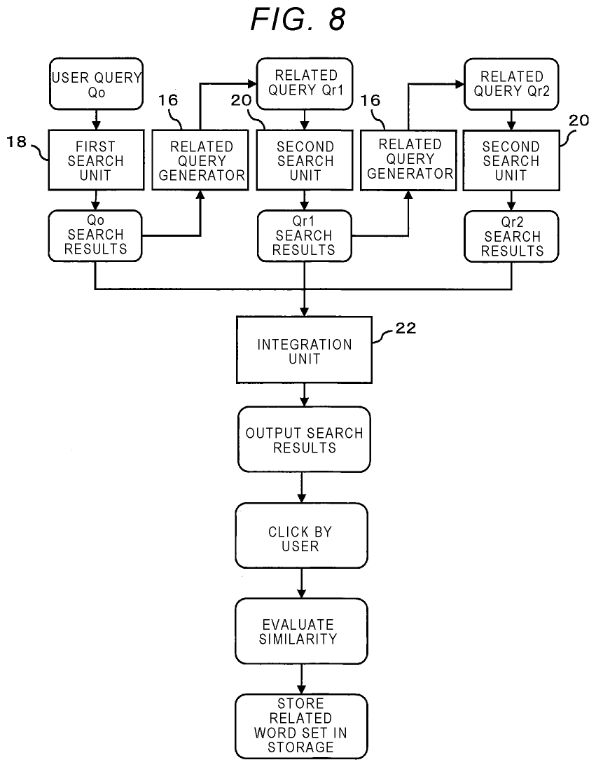

FIG. 8 schematically shows a flow of further another process according to the present exemplary embodiment. In the process shown in FIG. 6, the related query generator 16 generates the related query Qr using the Qo search results obtained by the first search unit 18. The related query generator 16 may generate plural related queries by repeating this process plural times as necessary.

That is, when a user query Qo is received by the query receiver 14, the user query Qo is output to the first search unit 18. The first search unit 18 accesses the database, executes a search with the user query Qo, outputs search results (that is, Qo search results) to the integration unit 22 and the related query generator 16.

The related query generator 16 generates a related query Qr1 to the user query Qo based on the Qo search results. Specifically, the related query generator 16 extracts a part of the Qo search results and employs the part of the Qo search results as the related query Qr1. The second search unit 20 accesses the database to execute a search for the related query Qr1, outputs search results (which may be referred to as “Qr1 search results”) to the integration unit 22 and the related query generator 16 again.

The related query generator 16 generates a related query Qr2 to the user query Qo based on the Qr1 search results. Specifically, the related query generator 16 extracts a part of the Qr1 search results and employs the part of the Qr1 search results as a related query Qr2. The second search unit 20 accesses the database to execute a search for the related query Qr2, and outputs search results (which may be referred to as “Qr2 search result”) to the integration unit 22.

It is assumed that a system receives a title of a paper and searches for a related paper. In this case, the user inputs, for example, “Graph Attention Networks” as the user query Qo. The first search unit 18 accesses the database for such a user query Qo, and outputs the followings in order of the similarity as Qo search results:
“Graph Neural Networks”,
“Graph Attention for Finance”,
“Hierarchical Graph Attention”,
   The related query generator 16 extracts a part of the Qo search results, for example, “Graph Neural Networks” listed at the top, employs the part of the Qo search results as the related query Qr1, and outputs the related query Qr1 to the second search unit 20. The second search unit 20 accesses the database to execute a search for the related query Qr1, and outputs search results (that is, Qr1 search results) to the integration unit 22. It is assumed that the Qr1 search results are as follows in order of the similarity:
“Graph Markov Neural Networks”,
“A Survey of Graph Neural Networks”,
“Graph Convolutional Networks”,
   The related query generator 16 extracts a part of the Qr1 search results, for example, “Graph Markov Neural Networks” listed at the top, employs the part of the Qo search results as a related query Qr2, and outputs the related query Qr2 to the second search unit 20. The second search unit 20 accesses the database to execute a search for the related query Qr2, and outputs search results (that is, Qr2 search results) to the integration unit 22.

The integration unit 22 integrates the three sets of search results, that is, the Qo search results, the Qr1 search results, and the Qr2 search results to generate a single set of search results, and outputs the single set of search results to the user terminal 26 as the search results for the user query Qo.

The user checks the search results displayed on the user terminal 26, and clicks any desired search result to make a request. The processor 12 receives the user's click and evaluates similarities of the related queries Qr1 and Qr2 to the user query Qo. Then, the processor 12 stores the related queries Qr1 and Qr2 having high similarities in the storage 24 as a related word set.

In this example, it can be said that the related query generator 16 is recursively used to generate related queries.

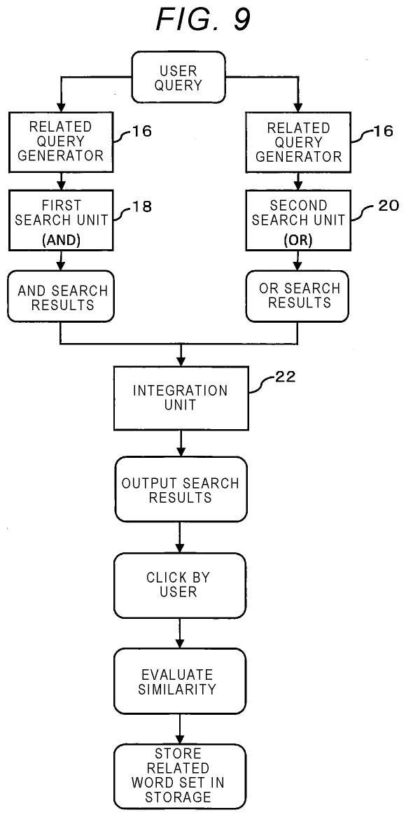

FIG. 9 schematically shows still another process according to the present exemplary embodiment. When a user query Qo is received, the related query generator 16 extracts a part of the user query Qo to generate a related query Qr for an AND search. Meanwhile, the related query generator 16 extracts a part of the user query Qo to generate a related query Qr for an OR search. The first search unit 18 executes an AND search with the user query Qo and the related query Qr, and outputs search results (which may be referred to as “AND search results”) to the integration unit 22. The second search unit 20 executes an OR search with the user query Qo and the related query Qr, and outputs search results (which may be referred to as “OR search results”) to the integration unit 22. The integration unit 22 integrates these search results into a single set of search results, and outputs the single set of search results to the user terminal 26.

It is assumed that the user query Qo is “ramen Yokohama”. Among these plural words, the related query generator 16 generates “Yokohama” as a related query Qr for an AND search and outputs “Yokohama” to the first search unit 18. Meanwhile, the related query generator 16 generates “Yokohama” as a related query Qr for an OR search and outputs “Yokohama” to the second search unit 20.

The first search unit 18 executes an AND search, and outputs the following search results in order of the similarity:
“Three Best Ramen at the West Exit of Yokohama Station”,
“Attractive Yokohama Originated Ramen”,
“Secrets behind Ramen Shop at Yokohama with Long Waiting Line”,

Further, the second search unit 20 executes an OR search, and outputs the following search results in order of the similarity:
“Recommended Sichuan Cuisine in Yokohama Chinatown”,
“Exquisite Italian in Yokohama”,
“Three Best Hakata Ramen Stands”,

The integration unit 22 integrates these search results, and outputs the followings to the user terminal 26 in order of the similarity as the search results for the user query Qo “ramen Yokohama”:
“Three Best Ramen at the West Exit of Yokohama Station”,
“Attractive Yokohama Originated Ramen”,
“Recommended Sichuan Cuisine in Yokohama Chinatown”,
“Exquisite Italian in Yokohama”, and
“Secrets behind Ramen Shop at Yokohama with Long Waiting Line”

The user checks the search results displayed on the user terminal 26, and clicks any desired search result to make a request. The processor 12 receives the user's click and evaluates a similarity of the related query Qr to the user query Qo, and evaluates a relationship between the related query Qr and the user query Qo. For example, when the user clicks “Secrets behind Ramen Shop at Yokohama with Long Waiting Line”, the processor 12 evaluates that “ramen” and “Yokohama” have high similarities, and evaluates that “Yokohama” is a related word with which an AND search is to be executed together with “ramen” and stores “ramen” and “Yokohama” in the storage 24.

The exemplary embodiment of the present disclosure has been described above. It is noted that the present disclosure is not limited to the exemplary embodiment, and various modifications may be made.

For example, in the present exemplary embodiment, a character string is described as the user query. Alternatively, data other than a character string, for example, image data or audio data may be received as the user query. In this case, when image data is received as the user query, the related query generator 16 may generate a related query to the image data directly or indirectly from the image data. When audio data is received as the user query, the related query generator 16 may generate a related query to the audio data directly or indirectly from the audio data.

Specifically, it is assumed that according to the example shown in FIG. 6, the first search unit 18 executes a search with the image data as the user query Qo, and plural pieces of image data P1, P2, P3, . . . are obtained as search results. In this case, the related query generator 16 selects one or plural pieces of image data from these pieces of image data and employs the selected image data as a related query Qr, and the second search unit 20 executes a search. It is assumed that plural pieces of image data p1, p2, p3 . . . are obtained as the search results by the second search unit 20 executing the search. In this case, the integration unit 22 integrates these search results and outputs “P1, P2, P3, p1, p2, p3, . . . ” to the user terminal 26.

In the present exemplary embodiment, Bob whose interest is close to that of Alice is generated as the related query to the user Alice. Alternatively, the related query may be generated using user information such as a user name, age, occupation, and affiliation group in addition to a user preference.

In the present exemplary embodiment, the search results of the user query Qo and the search results of the related query Qr are integrated at a ratio of 1:1 by the integration unit 22. The integration ratio may be changed to any ratio. Specifically, based on a certainty factor of the search results, the integration ratio of the search results having a high certainty factor may be set to be relatively high, and the integration ratio of the integration results having a low certainty factor may be set to be relatively low. Here, the term “certainty factor” refers to a degree of reliability. When a similarity of a search result is relatively high, a certainty factor of the search result is also high. When a similarity of a search result is relatively low, a certainty factor of the search result is also low.

Specifically, when the top similarity of the search results for the user query Qo is 0.9 and the top similarity of the search results for the related query Qr is 0.6, the search results for the user query Qo have a higher certainty factor than the search results for the related query Qr have. It is assumed that a ratio of the certainty factors is 3:2. In this case, both search results may be integrated at a ratio of 3:2 instead of 1:1 according to the ratio of the certainty factors.

In the present exemplary embodiment, the search results for the user query Qo and the related query Qr are integrated and presented to the user as the search results for the user query Qo. Alternatively, plural related queries Qr may be generated and search results for each of the plural related queries Qr may be simply presented to the user.

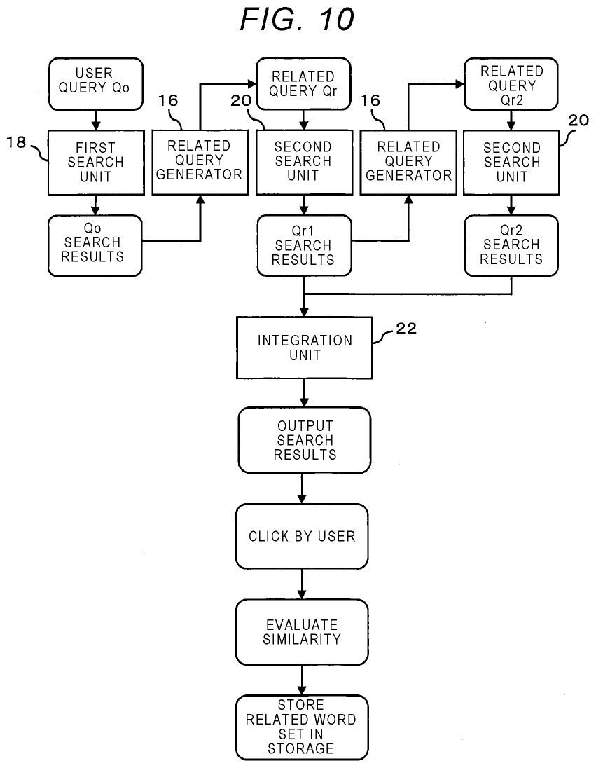

FIG. 10 shows a flow of the process in this case. The flow shown in FIG. 10 is different from that shown in FIG. 8 in that the Qo search results are not output to the integration unit 22 and that the integration unit 22 integrates only the Qr1 search results and the Qr2 search results and outputs the integrated search results. For example, it is assumed that the user query Qo is “Graph Attention Networks” and the related query generator 16 generates “Graph Neural Networks” and “Graph Markov Neural Networks” as related queries. In this case, only search results for “Graph Neural Networks” and search results for “Graph Markov Neural Networks” are integrated and output to the user terminal 26.

The user may optionally specify a form of search results from the user terminal 26. For example, the user appropriately selects and designates any of the followings:
(1) search results including search results for a user query,
(2) search results not including search results result for a user query,
(3) search results including (i) search results for a user query and (ii) search results for a single related query, and
(4) search results including (i) search results for a user query and (ii) search results for n related queries (where n≥2).

Further, in FIG. 8, the related query Qr2 is generated from the search results for the related query Qr1. Alternatively, the user may appropriately select and designate the number of times C the process of generating a related query from certain search results is repeated. The user may designate the number of times C depending on appropriateness of the user query. Specifically, the user may decrease the number of times C when he or she believes that the user query is appropriate, and increase the number of times C when he or she believes that the user query is inappropriate.

In the present exemplary embodiment, when the user inputs plural words as the user query Qo, a part of the input words is employed as the user query, the remaining part is employed as the related query, and searches are executed. It is noted that how to divide the input plural words may be optionally set. For example, a first half of the plural words may be employed as the related query, and the second half of the plural words may be employed as the user query. Alternatively, when the user inputs three or more words, a first word may be employed as the user query and the remaining two or more words may be employed as the related query. In short, an apparatus may only need to automatically generate the related query from the query input by the user, independent of a user intention.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information search apparatus comprising:
a receiver configured to receive an input of a user; and
a processor configured to execute a program to
execute a first search based on a query input to the receiver to generate first search results,
generate a related query from the query,
execute a second search based on the related query to generate second search results,
integrate the first search results and the second search results into a set of search results, and
output the set of search results as search results for the query.

2. The information search apparatus according to claim 1, wherein
the processor is configured to generate the related query from the first search results.

3. The information search apparatus according to claim 2, wherein
the processor is configured to employ the first search results as the related query.

4. The information search apparatus according to claim 1, wherein
the processor is configured to employ a part of the query as the related query.

5. The information search apparatus according to claim 1, wherein
the processor is configured to generate the related query from user information of the user who inputs the query.

6. The information search apparatus according to claim 5, wherein
the processor is configured to generate the related query from a preference included in the user information of the user.

7. The information search apparatus according to claim 1, wherein
the processor is configured to, in integrating the first search results and the second search results into the set of search results, change an integration ratio and outputs the set of search results as the search results for the query.

8. The information search apparatus according to claim 7, wherein
the processor is configured to
calculate a certainty factor of the second search results, and
change the integration ratio based on the certainty factor.

9. The information search apparatus according to claim 1, wherein
the processor is configured to
calculate first similarities of the first search results to the query,
calculate second similarities of the second search results to the related query, and
in integrating the first search results and the second search results into the set of search results, sort the first search results and the second search results based on the first similarities and the second similarities and output the set of search results as the search results for the query.

10. The information search apparatus according to claim 1, wherein
the processor is configured to generate a plurality of the related queries.

11. The information search apparatus according to claim 10, wherein
the related queries comprise at least a first related query and a second related query, and
the processor is configured to
generate the first related query from the first search results, and generate the second related query from search results generated by executing a search based on the first related query.

12. The information search apparatus according to claim 11, wherein
the processor is configured to
employ the first search results as the first related query, and
employ the search results generated by executing the search based on the first related query as the second related query.

13. The information search apparatus according to claim 1, wherein
the processor is configured to generate the related query in a form of at least one of character data, image data, or audio data.

14. An information search apparatus comprising:
a receiver configured to receive an input of a user; and
a processor configured to execute a program to
generate at least a first related query and a second related query from a query input to the receiver,
execute a third search based on the first related query to generate third search results,
execute a fourth search based on the second related query to generate fourth search results,
integrate the third search results and the fourth search results into a set of search results, and
output the set of search results as a search results for the query.

15. A non-transitory computer readable medium storing a program that causes a computer to execute information search processing, the information search processing comprising:
receiving an input query;
executing a first search based on the query to generate first search results;
generating a related query from the query;
executing a second search based on the related query to generate second search results;
integrating the first search results and the second search results into a set of search results; and
outputting the set of search results as search results for the query.
